(19) United States
(12) Patent Application Publication
(10) Pub. No.: US 2008/0270030 A1
(43) Pub. Date: Oct. 30, 2008

(54) Real-time Stadium and Sports Weather Network

(76) Inventor: Rhonda L. Copley, Orlando, FL (US)

Correspondence Address: RHONDA L. COPLEY, 4700 MILLENIA BLVD., SUITE 175, ORLANDO, FL, 32839, US

(21) Appl. No.: 11/740,460

(22) Filed: Apr. 26, 2007

(51) Int. Cl. G01W 1/02

(52) U.S. Cl. 702/3

(57) ABSTRACT

A method and system for providing a real time weather information of a sports location, wherein one or more sensors access and transmit one or more real time meteorological parameters to a processing system. The processing system performs zero, one or more operations on the real time meteorological parameters to obtain the real time weather information, and transmits the real time weather information to one or more output devices.

### BACKGROUND

A sports event depends on a plurality of factors, the plurality of factors comprises a real time weather information of a sports location wherein the sports event is being organized. A need is felt to obtain the real time weather information of the sports location.

### BRIEF DESCRIPTION OF THE DRAWINGS

FIG. 1. denotes an embodiment of the invention depicting a block diagram of a real time weather information system.

FIG. 2. denotes an embodiment of the invention depicting a block diagram of a real time weather information system at a hardware level wherein a processing system is connected to the one or more sensors.

FIG. 3. denotes an embodiment of the invention depicting a flow diagram of the steps for providing a real time weather information of a sports location.

### DESCRIPTION OF THE PREFERRED EMBODIMENT

A real time weather information could enable making a plurality of decisions in relation to a sports event, the plurality of decisions could comprise a change in a schedule of the sports event, a specific advertising scheme based on a viability of the sports event, a change in rules of the sports event. The real time weather information relates to a plurality of real time meteorological and sensor parameters from the sports location.

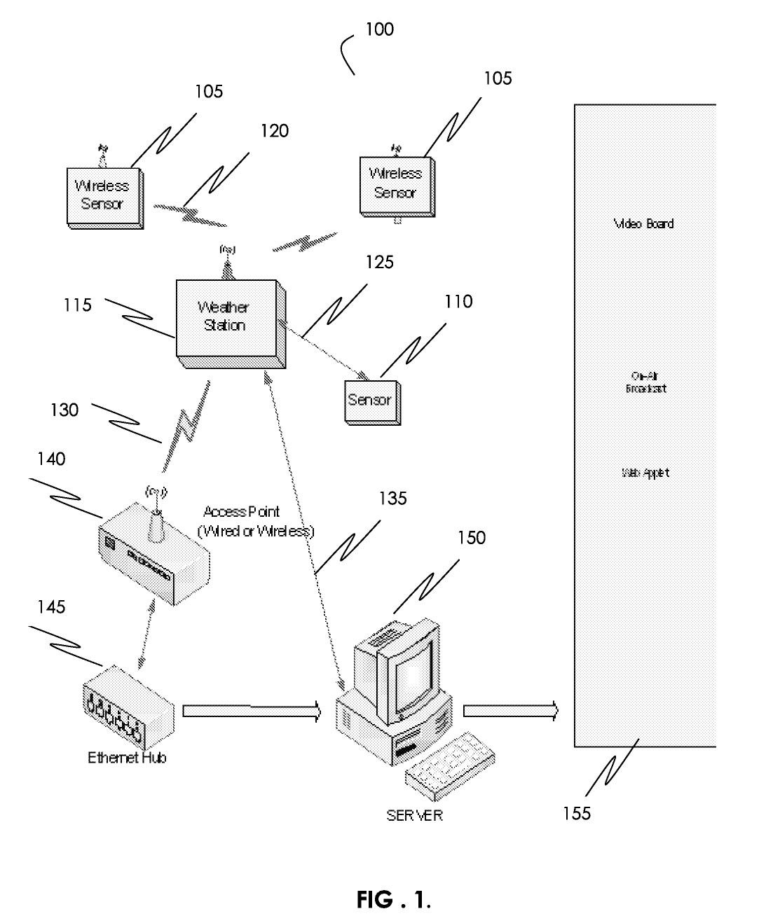

In an embodiment of the invention, as depicted in FIG. 1., the system (100) could comprise of one or more sensors (105, 110) for accessing one or more real time meteorological or sensor parameters. The one or more sensors can be a wireless sensor (105) or a wired sensor (110) and are placed at a plurality of locations around the sports location to be monitored. The one or more sensors can be an electrical sensor, a mechanical sensor or a digital sensor based on a type of real time meteorological parameter to be accessed and are responsible for streaming out the real time meteorological parameters. A sensor can transmit a reading as the reading is acquired or at a set interval, the set interval could be set to a minute.

The one or more sensors sense a plurality of electrical characteristics, mechanical characteristics, or monitor a plurality of digital counts to determine the real time meteorological parameters. The real time meteorological parameters at the sports location can be an air temperature, a soil temperature, a water temperature, a humidity measure, a barometric pressure, a rainfall measure, a soil moisture, a wind speed, or a wind direction. A sensor could access one real time meteorological parameter or a plurality of real time meteorological parameters.

As depicted in the embodiment (100), the wireless sensor (105) or the wired sensor (110) can be connected to a communication system, which comprises of a wireless channel (120) or a wired channel (125) for connecting the wireless sensor or the wired sensor respectively through a weather station (115). The weather station, forming part of the wired channel or the wireless channel, enables transmission of the real time meteorological parameters from the one or more sensors to a processing system (150). The communication channel can further comprise of a wireless access point (130) or a wired access point (135) for connecting the weather station (115) to the processing system (150), the access point further connected through a receiver (140) and an Ethernet hub (145). The communication system can be a network that enables transmission of the real time meteorological parameters to one or more processing systems (150). The one or more processing systems comprise one or more of a controller, a processor, and a software.

In an embodiment of the invention, the one or more processing system can either perform zero operations on the real time meteorological parameters, or one or more operations on the real time meteorological parameters to obtain a real time weather information. As for example, the one or more processing systems can perform a plurality of mathematical operations on the real time meteorological parameters and obtain the real time weather information in the form of a plurality of calculated values that comprise a heat index, a wind chill, or a vertical wind differential.

The one or more processing systems (150) can be connected to one or more output devices (155). The one or more output devices comprise one or more of a server application, a storage device, a web based application, a display, a cable display, a on-air broadcast and a video board. In an embodiment of the invention, the server application logs the real time weather information for later retrieval. In another embodiment, the storage device can be used to store the real time weather information. Further, an embodiment could also comprise of a display that is web-based application, which receives the real time weather information for display through a TCP/IP protocol. A computer display can also be used, wherein the real time weather information can be customized and shown as changes occur in the real time weather information in a live manner. A customizable onscreen display can also simultaneously feed the real time weather information to a video board though a standard PC (personal computer) video output.

As depicted in embodiment 100, the flow of data is bi-directional. In another embodiment, the flow of data related to real time weather information can be in a single direction from the one or more sensors to the server software. The server software would log the real time weather information for later use, or could simultaneously send the real time weather information to the output system.

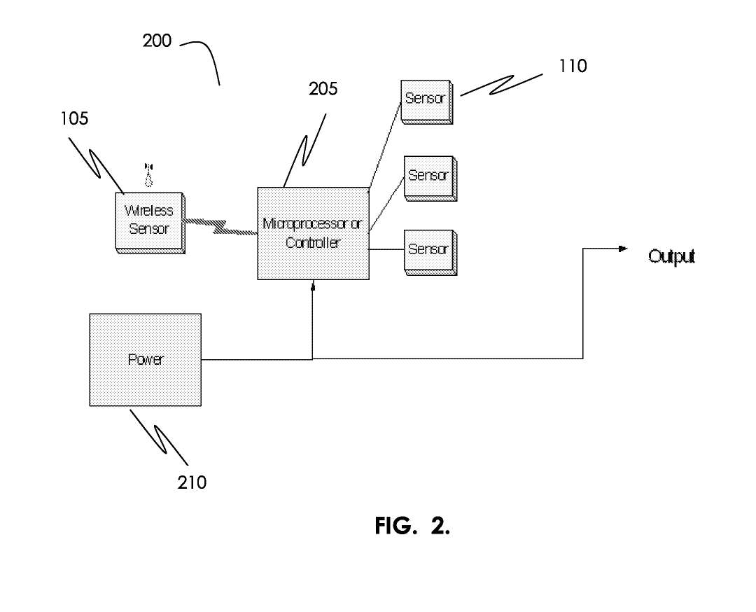

Another embodiment (200) of the invention (as in FIG. 2) depicts the block diagram at a hardware level. One or more sensors (105, 110) comprising of wireless sensors (105) and wired sensors (110) connect to a processing system (205) through a communication system. The communication system could be an onboard device (not shown in figure), for example an onboard network chip, which enables transmission of the real time meteorological parameters. The one or more sensors could perform an initial processing on the real time meteorological parameters before transmitting the real time meteorological parameters to the first communication device. The processing system (205) can be a microprocessor or a micro-controller that processes the real time meteorological parameters. The processing system can be powered by a power supply (210). The processing system can transmit the real time weather information to an output device such as a server application, a storage device, a web based application, a display, a cable display, a on-air broadcast or a video board.

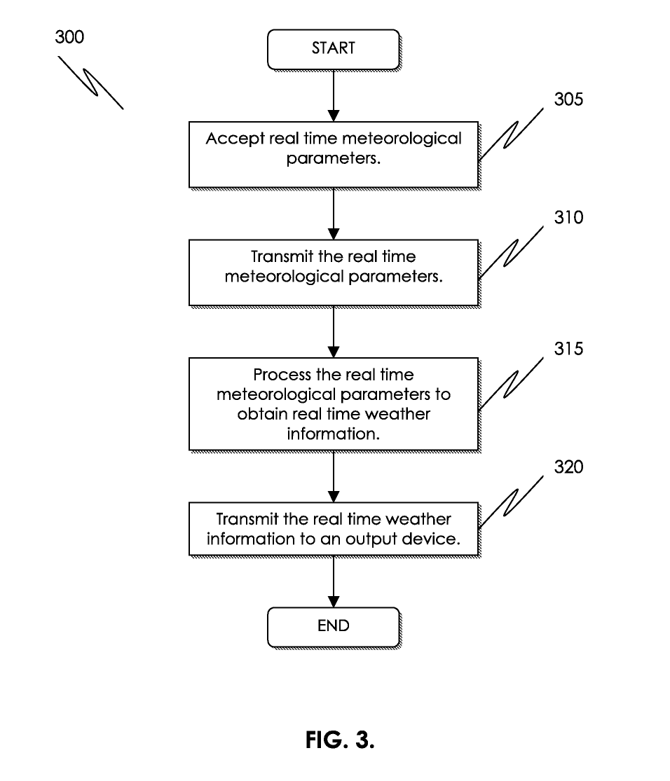

FIG. 3. denotes an embodiment (300) of the invention depicting a flow diagram of the steps for providing a real time weather information of a sports location. As depicted in step 305, one or more sensors access one or more real time meteorological parameters at the sports location. The one or more sensors could be situated at one or more physical locations at the sports location. The sports location can be a sports stadium or track, an indoor arena, an outdoor arena or an entertainment venue, for example, the organizers for an entertainment event or a sports match could need to determine the climatic conditions beforehand. The real time meteorological parameters could comprise one or more of an air temperature, a soil temperature, a water temperature, a humidity measure, a barometric pressure, a rainfall measure, a soil moisture, a wind speed, and a wind direction. The one or more sensors comprise one or more of an electrical sensor, a mechanical sensor, a digital sensor, which sense one or more electrical characteristics, one or more mechanical characteristics, and one or more digital counts respectively.

As depicted in step 310, the real time meteorological parameters can be transmitted to a processing system (150, 205) using a communication system. The communication system can be an onboard network connector, or a network. The communication system could work transmission method, which could be a wired transmission or a wireless transmission. In an embodiment, the transmission method could be based on a bi-directional transmission flow. In another embodiment, the transmission method could be based on a unidirectional transmission flow. Further, the one or more sensors could transmit the real time meteorological parameters continuously, which means immediately on accessing the real time meteorological, or transmit at periodic intervals, which could be on collecting the real time meteorological parameters and streaming the real time meteorological parameters to the processing system.

The processing system comprises one or more of a controller, a processor, and a software. As in step 315, the processing system performs zero, one or more operations on the one or more real time meteorological parameters to obtain the real time weather information. In an embodiment of the invention, the one or more operations could comprise of one or more mathematical calculations on the real time meteorological parameters to provide the real time weather information, which comprises one or more of a heat index, a wind chill, and a vertical wind differential. In another embodiment of the invention, the processing system could be a server software application.

As in step 320, the real time weather information is transmitted to one or more output devices. The output device comprises one or more of a web based application, a display, a cable display, an on-air broadcast and a video board. In an embodiment of the invention, the processing system can be a server software application, which collects, stores and interprets the real time meteorological parameters to obtain the real time weather information and transmits the real time weather information to the output device, which could be an onscreen computer display program. The onscreen computer display program could be customized to show the real time weather information as it changes. At the same time, the real time weather information can be transmitted to a web-based application, and a video board for displaying the real time weather information on a web page and a standard PC (personal computer) video output respectively. In yet another embodiment of the invention, the performing step can further comprise the processing system, such as a server software, logging the one or more real time meteorological parameters and the real time weather information to a storage device for future use. The processing system can simultaneously send data to an onscreen display program and to a web based application for display purposes.

In another embodiment of the invention, the performing step further comprises branding the real time weather information. The branding can be done by naming the real time meteorological parameters or the real time weather information in accordance with the marketing needs of the sports location. Additionally, the real time meteorological parameters or the real time weather information can be associated with a sponsor or an advertiser, for example, an on-field or on-court temperature or moisture can be branded as a “slip-index”, a “swirl factor” or a “turf temp” and be sponsored by an advertiser or company. The “swirl factor” accounts for a vertical and a horizontal wind shear and can be accessed and processed by placing one or more sensors at a field and at a plurality of vertical levels within the sports location. The wind shear graphic can show a speed and a direction, and one or more measurements of the speed and the direction in relationship to a field or a stadium geographic position and a stadium orientation. As for example, a graphic based on the real time weather information can be superimposed onscreen on top of a video image during games, the graphic depicting an arrow that shows the direction of the wind in relation to a field goal kicker and a goal post.

Further, a content on the one or more output devices can be based on one or more customers. In an embodiment of the invention, an onsite, a television and a web audience can see the winds shift direction and change velocity, or the wind direction in relationship to a field position and an orientation, as one or more players attempt a field goal, pitch or bat. An output device could comprise of a custom display with sponsorship branding, the sponsorship branding appears with the real time weather information in graphic form. The graphic form can be a virtual goal post, or a batter's plate with a direction and a length arrow based on the real time weather parameters. The custom display provides a dynamic view and helps grab the attention of the viewer.

1. A method for providing a real time weather information of a sports location, the method comprising:
accessing one or more real time meteorological parameters using one or more sensors at the sports location,
transmitting the one or more real time meteorological parameters to a processing system using a communication system based on a transmission method,
performing zero, one or more operations on the one or more real time meteorological parameters to obtain the real time weather information using the processing system, and
transmitting the real time weather information to one or more output devices.

2. The method of claim 1, wherein the sports location comprises one of a sports stadium or track, an indoor arena, an outdoor arena, an entertainment venue.

3. The method of claim 2, wherein the one or more meteorological parameters comprises one or more of an air temperature, a soil temperature, a water temperature, a humidity measure, a barometric pressure, a rainfall measure, a soil moisture, a wind speed, and a wind direction.

4. The method of claim 3, wherein the transmission method comprises one or more of a wired communication method or a wireless communication method.

5. The method of claim 4, wherein the transmission method further comprises of a unidirectional flow and a bi-directional information flow.

6. The method of claim 5, wherein the transmission method further comprises a continuous transmission and a periodic transmission.

7. The method of claim 6, wherein the processing system comprises one or more of a controller, a processor, and a software.

8. The method of claim 7, wherein the one or more output device comprises one or more of a web based application, a display, a cable display, an on-air broadcast and a video board.

9. The method of claim 8, wherein a content on the one or more output device varies based on one or more customers.

10. The method of claim 9, wherein the performing step further comprises the processing system logging the one or more real time meteorological parameters and the real time weather information.

11. The method of claim 10, wherein the performing step further comprises branding the real time weather information.

12. The method of claim 11, wherein the performing step further comprises adding one or more advertisements to the real time weather information.

13. The method of claim 12, wherein the one or more operations comprises one or more mathematical calculations.

14. The method of claim 13, wherein the real time weather information comprises one or more of a heat index, a wind chill, and a vertical wind differential.

15. A system for providing a real time weather information of a sports location, the system comprising:
one or more sensors located at the sports location for accessing one or more real time meteorological parameters,
one or more processing system connected to the one or more sensors through a communication system for processing the one or more real time meteorological parameters to obtain the real time weather information, and
one or more output devices connected to the one or more processing system.

16. The system of claim 15, wherein the one or more sensors comprises a wired sensor and a wireless sensor.

17. The system of claim 16, wherein the one or more sensors comprises one or more of a electrical sensor, a mechanical sensor, a digital sensor.

18. The system of claim 17, wherein the communication system comprises one of a communication channel, a network, an onboard connector.

19. The system of claim 18, wherein the one or more processing systems comprise one or more of a controller, a processor, and a software.

20. The system of claim 19, wherein the one or more output devices comprise one or more of a server application, a storage device, a web based application, a display, a cable display, a on-air broadcast and a video board.
